(19) United States
(12) Patent Application Publication
(10) Pub. No.: US 2008/0273420 A1
(43) Pub. Date: Nov. 6, 2008

(54) Domestic Appliance

(76) Inventors: Reinhard Ferk, Ludmannsdorf (AT); Roland Dorfer, Keutschach (AT)

Correspondence Address: PHILIPS INTELLECTUAL PROPERTY & STANDARDS, PO BOX 3001, BRIARCLIFF MANOR, NY, 10510-8001, US

(21) Appl. No.: 11/570,162

(22) PCT Filed: Jun. 6, 2005
(86) PCT No.: PCT/IB05/51829

§ 371 Date: Dec. 7, 2006

(30) Foreign Application Priority Data
Jun. 9, 2004 (EP) 04102614.7

(51) Int. Cl. A47J 43/08; A47J 43/04

(52) U.S. Cl. 366/206; 241/169.1; 366/314

(57) ABSTRACT

The present invention relates to a domestic a nutritional item such as e.g. a blender comprising a base uni covered by a lid (2). To allow for enhanced operator conven controlling the motor (22) is located on the lid (2). The lid sending control signals from the control panel (14) to the m receiver unit (10) located in the base unit (4). In preferred e used as transmitting medium for the control signals. pliance (1) for use in processing (4) with motor (22) and a jar (3) ence, the control panel (14) for encloses an emitter unit (5) for (22) in the base unit (4) via a bodiments, the jar (3) itself is used as transmitting medium for the control signals.

The present invention is related to a domestic appliance, e.g. for use in processing nutritional items.

Domestic appliances of various types have been around for many years. Domestic appliances, as contemplated in the present invention may include, without limitations, blenders, food processors, mixers, and any other appliance having a receptacle to be covered by a lid during operation, e.g. during processing nutritional items.

One traditional mixing device is a conventional stand-alone blender typically comprising some type of a stand or base in which the blender motor is housed, a jar or other receptacle into which the nutritional items to be mixed are placed, and a lid covering the opening to the receptacle.

A continual design concern relates to safety during operation. It is important to maintain the nutritional items being mixed within the blender receptacle. The blending cycles can cause particles of the items being mixed to be hurled outside of the receptacle at high velocities.

It is equally important to minimize the risk of injuries to the persons operating the blending machines. Injuries might occur, for example, if the operator were to inadvertently insert a limb into the receptacle during operation of the blending machine and happened to touch the rotating blade.

For example, WO 02/060306 discloses an electric household appliance for processing foods comprising a main body including an electric motor and its control means, a jar comprising a tool designed to be driven by the motor unit and a lid for covering the jar, and a safety device including a transceiver housed in the main body and a transponder in the lid. Transceiver and transponder are designed to be coupled by a radio frequency or microwave electromagnetic field when the jar is installed on the main body. This makes sure that the appliance operates only, if the jar covered by the lid is well mounted on the main body.

Another important concern especially relating to domestic appliances that are to be used mainly by common users and not specialized operators consists in the operation of the domestic appliance to be as convenient as possible.

It is an object of the present invention to improve operating convenience of domestic appliances.

The present invention provides a domestic appliance comprising a base unit with a driving unit, a receptacle with a tool designed to be driven by the driving unit and a lid to cover the receptacle, wherein the lid comprises a control unit for controlling the driving unit and an emitter unit for sending control signals from the control unit to a receiver unit located in the base unit and connected to the driving unit for receiving the control signals and transmitting them to the driving unit. By controlling the driving unit of the appliance via the lid, manageability is improved, as the lid with control unit is reachable and visible independently of the orientation of the domestic appliance. Furthermore, there is no need for stooping for taller users, as there is with respect to conventional domestic appliances having the control unit located in the base unit.

In preferred embodiments according to the present invention, the control signals are transmitted form the emitter unit to the receiver unit via the material of the receptacle. This improves security, because the driving unit would receive a start signal only with the lid covering the receptacle and, if receptacle and base unit are separate parts of the domestic appliance, with the receptacle mounted on the base unit.

Preferably, the emitter unit emits ultrasonic waves or electromagnetic waves in the range of infrared or visible light. The electromagnetic waves are preferred in particular, when transmitting the control signals via the receptacle's material or optical fibers.

For further improving security, the control unit preferably comprises a safety switch for controlling the lid's position with respect to the receptacle. The safety switch may be checked by the control unit for example periodically or before sending a control signal or when starting the domestic appliance. The appliance will then start processing only if the lid is correctly placed on the receptacle.

Preferably, the lid further comprises an encoding unit for encoding the control signals and the base unit further comprises a decoding unit for decoding the control signals. By doing so, interferences with other signals form emitter units outside the domestic appliance are avoided.

In order to minimize energy consumption, the control unit in preferred embodiments is arranged to switch into stand-by mode after a certain amount of time of no operation of the control unit and back to operating mode, if the control unit is externally activated. Preferably, the control unit eventually checks the security switch, if there is one, and has the emitter unit send signals asking, whether the lid is on the right base unit, before sending said control signals when returning to operating mode for higher security. This can be done as well, when the domestic appliance is started.

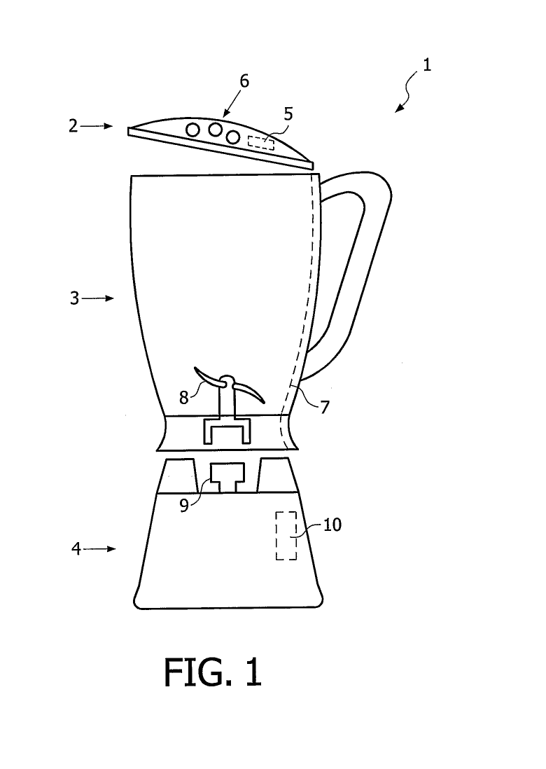

FIG. 1 shows a stand-alone blender in accordance with the present invention;

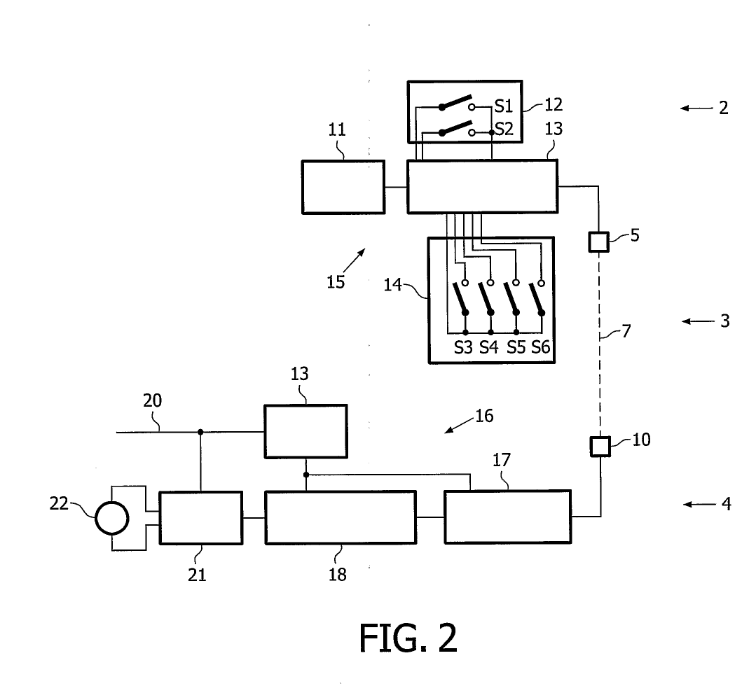

FIG. 2 shows schematically a connection diagram for the blender of FIG. 1.

FIG. 1 shows a domestic appliance 1, in this particular, not limiting example a stand-alone blender with a lid 2, a jar 3 as receptacle and a base unit 4. The nutritional items to be blended are filled into the jar 3. The blending is done by rotating the blades 8. This to happen, the jar 3 has to be correctly mounted onto the base unit 4. The jar 3 is correctly mounted, when the clutch 9 of the base unit 4 is mechanically connected with the blades 8 of the jar 3. The clutch 9 is connected to a motor not shown in FIG. 1 for sake of simplicity. When the jar 3 is correctly mounted onto the base unit 4, the motor can drive the blades 8 depending on control signals controlling for example start and end of the rotation and the rotating velocity.

The control signals are generated in a control unit integrated in the lid 2, when the user touches control elements 6 on top of the lid 2. The control elements 6 could e.g. start and stop the blender and change rotating velocities. The domestic appliance 1 according to the present invention is very convenient for the user to use as, compared to conventional appliances having the control element on one side of the base unit, the control elements 6 are always clearly visible and easy to reach, independently of the position of the appliance for example on a kitchen table or between other domestic appliances. This prevents the user of inadvertently touching the wrong control element 6 such as accelerating the motor instead of stopping it.

The control signals for the motor or some other driving device are generated in a control unit located in the lid 2 upon touching one of the control elements 6 and then transmitted to the emitter unit 5 for sending them to the base unit 4. There, the control signals are received by the receiver unit 10 and transmitted to the driving unit controlling the motor or some other suitable driving device.

The emitter unit can be arranged to emit any signal from electric to acoustic to electromagnetic. However, electric signals are not favored, because for security reasons one would like to avoid electric cables for transmitting the control signals. Electric cables are prone to corrosion in a kitchen environment and when processing liquid nutritional items, especially, if the insulation is damaged from use, and can injure the user. It is therefore preferred to use types of signals that can be transmitted via air or optical conductors, for example acoustic or ultrasonic waves or electromagnetic waves like radio frequencies, visible or infrared light. Acoustic waves might be unpleasant for the user, when he is using the appliance for a longer time. Ultrasonic signals might be disagreeable for pets, especially dogs.

In preferred embodiments optical signals and optical conductors are used. The advantage is, that the lid 2 and the jar 3 on the one side and the jar 3 and the base unit 4 on the one side have to be well aligned for sending the control signals from the lid 2 to the base unit 4. Thus, the motor could receive a start signal only if, the jar 3 is well mounted on the base unit 4 and the lid 2 is well fixed on the jar 3. By doing so, one avoids particles of the items being mixed to be hurled outside of the jar 3 at high velocities.

Preferably, one uses the material of the jar 3 itself as optical conductor. The resulting signal-transmitting path 7 is schematically shown in FIG. 1 as a dotted line. The jar's material has consequently to chosen to transmit the optical signal in the given wavelength range. In the present example, infrared light has been chosen for signaling and a transparent plastic as jar material.

As no additional parts like cables or optical fibers are necessary, manufacturing costs are lowered. Less parts also means less probability of failure of the domestic appliance 1, thus increasing customer contentment. A further major advantage of using the jar 3 itself as optical conductor is that the appliance can be operated only under best conditions, i.e. not only must jar 3 and lid 2 be well fixed and mounted, but sufficiently clean, too. If the jar 3 and the lid 2 were stained at the place where they contact each other, the signal could not be transmitted and the motor would not start rotating the blades 8.

The functions of the domestic appliance according to the present invention will be discussed more in detail with reference to FIG. 2. FIG. 2 shows schematically a connection diagram for the blender illustrated in FIG. 1.

The lid 2 contains the emitter unit 5, in this example an infrared light emitting diode, and the control unit 15 including a power supply in form of a battery 11, a control panel 14 with four switches S1, S2, S3, S4 designed as push buttons and having the function of control elements 6 of FIG. 1, a security switch 12 with two mechanical switches S1, S2 and a microcontroller 13.

The jar 3 is represented by the signal transmitting path 7 between the emitter unit 5 and the receiver unit 10 of the base unit 4. In addition to the receiver unit 10, the base unit 4 contains the driving unit 16 including a signal shaping unit 7, a microcontroller 18, an internal power supply 19 connected to an external power supply 20, and a motor control unit 21 for the motor 22.

Once the user touches a first push-button of the control panel 14 to start blending, the microcontroller 13 first checks with the security switch 12 whether both switches S1 and S2 are closed. The switches S1 and S2 are mechanical switches located at two different places of the boundary between the lid 2 and the jar 3 and can be only closed, if the lid 2 is correctly fixed on and covering the opening to the jar 3. During operation of the blender, the microcontroller 13 will periodically check with the security switch 12, whether the lid 2 is still fixed on the jar 3. If not, the microcontroller 13 will immediately stop the blending.

If the lid 2 is correctly fixed on the jar 3, in preferred embodiments according to the invention, the microcontroller 13 will encode a first signal to check with the base unit 4, whether the lid 2 fixed on the jar 3 is the right lid to this particular appliance. This is especially important for users having large premises with several similar domestic appliances.

This encoded signal is transmitted to the emitter unit 5 that sends the signal to the receiver unit 10 in the base unit via the jar material along the path 7. In embodiments having this special function of making sure, that lid 2 and base unit 4 fit together, the emitter unit 5 will preferably be a transceiver. The receiver unit 10 would be a transceiver as well, instead of a mere photodiode sensitive in, in the present example, the infrared range.

From the receiver unit 10 the signal is transmitted to the signal shaping unit 17. There, the signal is decoded and eventually amplified before being further transmitted to the microcontroller 18. The person skilled in the art will appreciate, that the standard functions of encoding and decoding may be integrated into the microcontroller or taken over by a separate unit. Encoded signals are especially useful in environments where external signals are present in a similar wavelength range. In case of infrared light, one would think e.g. of remote controls of televisions or communication links between computers and accessory equipment such as printer, modem and the like. An interference of these external signal with the control signals of the domestic appliance according to the present invention could lead to wrong signals arriving at the base unit and thus a misfunction of the appliance.

Once the first control signal testing the relation lid to base unit is arrived at the microcontroller 18, it is answered by the microcontroller transmitting an appropriate signal to the signal shaping unit for encoding, the signal shaping unit further transmitting it to the receiver unit 10 for sending it to the emitter unit 5. The emitter unit 5 transmits the answer signal to the microcontroller 13, where the signal is decoded and processed. The control unit 15 is now ready to accept orders from the user via the control panel 14.

Depending on what button is pushed by the user, respectively which one of the switches S3, S4, S5, S6 is activated, the microcontroller 13 generates an appropriate control signal for sending to the driving unit 16 in the base unit 4. This control signal is received form the receiver unit 10 and after decoding in the signal shaping unit 17 processed by the microcontroller 18 into a valid signal for the motor control unit 21. The motor control unit 21 causes the motor to start, stop, change velocity or direction of the rotation depending on the signal received from the control unit 15 of the lid 2.

The base unit 4 is connected to an external power supply 20 at a voltage of e.g. 220-230 V via an internal power supply 19 supplying the driving unit 16 and in particular the motor 22 via the motor control unit 21 with the appropriate voltage. The lid 2 has only an internal power supply 11 in form of a battery, while in some embodiments additional electrical energy can be supplied via the emitter—receiver link.

For improved user convenience the lifetime of the battery should be as long as the lifetime of the whole domestic appliance. The battery has to be housed in the lid in a waterproof way to allow for cleaning even in a dishwasher. Therefore, the battery should preferably not have to be exchanged during the lifetime of the appliance.

To optimize the lifetime of the battery 11, control units 15 of preferred embodiments have the special feature to switch into stand-by mode after a certain time without operation of the appliance, i.e. no activation of any control element of the control panel 14. Once a control element is again activated, the control unit 15 switches back to operation mode.

Before sending the first control signal concerning the motor 22, the control unit 15 proceeds in a similar way to when the appliance is started: The security switch 12 is checked and depending on the embodiment, the fit of lid and base unit is checked as well. Only if the check is positive, a control signal for the motor 22 is sent to the base unit 4. Preferably, a first activation of any control element would induce the change of mode from “stand-by” to “operation” and start said checking procedure and only the second activation of any control element would cause a control signal for the motor 22 to be generated by the control unit 15 and sent to the driving unit 16 of the base unit 4.

The invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications with the proper scope of the appended claims. For example various combinations of the features of the following dependent claims could be made with the features of the independent claim without departing from the scope of the present invention.

### LIST OF REFERENCE NUMERALS

1. domestic appliance
2. lid
3. jar
4. base unit
5. emitter unit
6. control elements
7. data transfer path
8. blade
9. clutch
10. receiver unit
11. battery
12. safety switch
13. microcontroller
14. control panel
15. control unit
16. driving unit
17. signal shaping unit
18. microcontroller
19. internal power supply
20. external power supply
21. motor control unit
22. motor

1. A domestic appliance comprising a base unit with a driving unit, a receptacle with a tool designed to be driven by said driving unit and a lid to cover said receptacle wherein the lid comprises a control unit for controlling said driving unit and an emitter unit for sending control signals from said control unit to a receiver unit in said base unit and connected to said driving unit for receiving said control signals and transmitting them to said driving unit.

2. The domestic appliance according to claim 1, wherein said control signals are transmitted from the emitter unit to the receiver unit via the material of the receptacle.

3. The domestic appliance according to claim 1, wherein the emitter unit is an emitter unit emitting electromagnetic waves in the infrared range.

4. The domestic appliance according to claim 1, wherein the emitter unit is an emitter unit emitting electromagnetic waves in the range of visible light.

5. The domestic appliance according to claim 1, wherein the emitter unit is an emitter unit emitting ultrasonic waves.

6. The domestic appliance according to claim 1, wherein said control unit comprises a safety switch for controlling said lid's position with respect to said receptacle.

7. The domestic appliance according to claim 1, wherein said control unit further comprises an encoding unit for encoding said control signals and wherein the base unit further comprises a decoding unit for decoding said control signals.

8. The domestic appliance according to claim 1, wherein said unit control unit is arranged to switch into stand-by mode after a certain amount of time of no operation of the control unit and back to operating mode, if said control unit is externally activated.

9. The domestic appliance according to claim 1, wherein said control unit is arranged to have said emitter unit send signals asking, whether the lid is on the right base unit, before sending control signals for the driving unit, when starting in operating mode.

10. The domestic appliance according to claim 1, wherein said control unit is arranged to switch into stand-by mode after a certain amount of time of no operation of the control unit and back to operating mode, if said control unit is externally activated, and to have said emitter unit send signals asking, whether the lid is on the right base unit, before sending control signals for the driving unit, when returning to operating mode.

11. The domestic appliance according to claim 6, wherein said control unit is arranged to switch into stand-by mode after a certain amount of time of no operation of the control unit and back to operating mode, if said control unit is externally activated, and to check the security switch as well as to have said emitter unit send signals asking, whether the lid is on the right base unit, before sending control signals for the driving unit, when returning to operating mode.
